(19) United States
(12) Patent Application Publication
(10) Pub. No.: US 2026/0227174 A1
(43) Pub. Date: Aug. 6, 2026

(54) SHAPE MEASUREMENT DEVICE AND SHAPE MEASUREMENT METHOD

(71) Applicant: HITACHI HIGH-TECH CORPORATION, Tokyo (JP)

(72) Inventors: Kenji MARUNO, Tokyo (JP); Masahiro WATANABE, Tokyo (JP); Tatsuo HARIYAMA, Tokyo (JP); Hirohito AKIYAMA, Tokyo (JP); Hidehiko KANDO, Tokyo (JP)

(21) Appl. No.: 18/869,450

(22) PCT Filed: Apr. 20, 2023
(86) PCT No.: PCT/JP2023/015716

§ 371 Date: Nov. 26, 2024

(30) Foreign Application Priority Data
Jun. 14, 2022 (JP) 2022-095601

(51) Int. Cl. G01B 9/02; G01B 9/02001; G01B 9/02091; G01B 11/24

(52) U.S. Cl. CPC G01B 9/0205; G01B 9/02011; G01B 9/02091; G01B 11/2441

(57) ABSTRACT

The shape of an object is measured with high accuracy by a probe having a measurement light optical path switching element including a first surface on which the measurement light from an optical element is incident, a second surface that reflects the measurement light incident from the first surface, a third surface that emits the measurement light reflected by the second surface to an object, a fourth surface that is in contact with the second surface, and a fifth surface that emits the measurement light having passed through the second surface to the object. An angle between a normal of the second surface and a rotation axis of the probe is greater than 45 degrees, an angle between a normal of the third surface and the rotation axis is less than 90 degrees, and a normal of the fifth surface is not parallel to the rotation axis.

### TECHNICAL FIELD

The present invention relates to a shape measurement device and a shape measurement method. The present invention claims priority to Japanese Patent Application No. 2022-095601 filed on Jun. 14, 2022, and the contents of that application are incorporated by reference into this application in designated countries where incorporation by reference of literature is permitted.

### BACKGROUND ART

As technology for measuring the shape of the bottom surface or side surface of a hole formed in an object, for example, PTL 1 discloses “a distance measurement device comprising a light emitting unit that outputs measurement light, a polarization state control unit that controls polarization of the measurement light output from the light emitting unit, and an optical path switching element that selectively emits the measurement light controlled by the polarization state control unit, in which the polarization state control unit controls the polarization so that the measurement light is emitted from the optical path switching element in a plurality of directions, and the optical path switching element captures reflected light used for measuring a distance to the object, the reflected light being reflected light of the measurement light emitted from the optical path switching element and being reflected by the object”.

### CITATION LIST

### Patent Literature

PTL 1: JP6513846B

### SUMMARY OF INVENTION

### Technical Problem

In the technology disclosed in PTL 1, when a distance between an emission surface of an optical element and the surface of the object is close and normal directions of the surfaces are close to each other, multiple reflections that cause measurement noise may occur when the measurement light is output inside the hole of the object, and the accuracy of shape measurement may decrease. In addition, reflection from the emission surface of the optical element may cause measurement noise, and the accuracy of shape measurement may decrease.

The invention has been made in consideration of the above points, and an object thereof is to measure the shape of an object with high accuracy by suppressing the generation of measurement noise.

### Solution to Problem

The present application includes a plurality of means for solving at least a part of the above problems, and examples of which are as follows.

To solve the above problems, a shape measurement device according to one aspect of the invention is a shape measurement device including a measurement head, the measurement head including a probe that is locked to a tip of the measurement head, a rotation unit that rotates the locked probe, and an optical element that emits measurement light to the probe, the probe includes an optical path switching element that switches an optical path of the measurement light incident from the optical element, the optical path switching element has a first surface on which the measurement light incident from the optical element is incident, a second surface that reflects the measurement light incident from the first surface, a third surface that emits the measurement light reflected by the second surface to an object, a fourth surface that is in contact with the second surface, and a fifth surface that emits the measurement light having passed through the second surface to the object, the optical path switching element is capable of controlling a reflection ratio of the measurement light at the second surface and includes a first transmissive member having the first surface, the second surface, and the third surface, and a second transmissive member having the fourth surface and the fifth surface, an angle between a normal of the second surface and a rotation axis of the probe is greater than 45 degrees, an angle between a normal of the third surface and the rotation axis is less than 90 degrees, and a normal of the fifth surface is not parallel to the rotation axis.

### Advantageous Effects of Invention

According to the invention, it is possible to suppress the occurrence of measurement noise and measure the shape of an object with high accuracy.

Problems, configurations, and effects other than those described above will become apparent from the following description of embodiments.

### BRIEF DESCRIPTION OF DRAWINGS

FIG. 1 is a schematic diagram showing a configuration example of a shape measurement device according to a first embodiment of the invention.

FIGS. 2(A) and (B) are diagrams showing the operation of a polarized beam splitter, where FIG. 2(A) shows a state in which a vibration direction of linearly polarized measurement light is a right-left direction of the drawing, and FIG. 2(B) shows a state in which a vibration direction of linearly polarized measurement light is a depth direction of the drawing.

FIG. 3 is a diagram showing a relationship between a first polarization state control unit, a second polarization state control unit, and an optical path switching element.

FIG. 4 is a diagram showing a relationship between the first polarization state control unit, the second polarization state control unit, and the optical path switching element.

FIG. 5 is a diagram showing a first configuration example of a distance measurement control mechanism.

FIG. 6 is a diagram showing an example of a method of obtaining a reflection position on the surface of an object T from a reflection intensity profile.

FIG. 7 is a diagram showing a second configuration example of a distance measurement control mechanism.

FIG. 8 is a diagram showing a third configuration example of a distance measurement control mechanism.

FIG. 9 is a diagram showing a relationship between the first polarization state control unit, the second polarization state control unit, and the optical path switching element in the third configuration example of the distance measurement control mechanism.

FIG. 10 is a schematic diagram showing a configuration example of a shape measurement device adopting a distance measurement device.

FIG. 11 is a schematic diagram showing another configuration example of a shape measurement device adopting a distance measurement device.

FIG. 12 is a diagram showing a configuration example of functional blocks of the shape measurement device.

FIG. 13 is a perspective view showing a first configuration example of the optical path switching element.

FIG. 14 is an arrow view of a tip part in the first configuration example of the optical path switching element.

FIG. 15 is an arrow view of the tip part in the first configuration example of the optical path switching element.

FIG. 16 is a perspective view showing a modification example of the first configuration example of the optical path switching element.

FIG. 17 is a diagram showing an optical path in the first configuration example of the optical path switching element.

FIG. 18 is a perspective view showing a second configuration example of the optical path switching element.

FIG. 19 is an arrow view of a tip part in the second configuration example of the optical path switching element.

FIG. 20 is an arrow view of the tip part in the second configuration example of the optical path switching element.

FIG. 21 is a perspective view showing a third configuration example of the optical path switching element.

FIG. 22 is a perspective view showing a fourth configuration example of the optical path switching element.

FIG. 23 is a diagram showing coordinate calculation in a first direction.

FIG. 24 is a flowchart showing a three-dimensional shape measurement process performed by a shape measurement system.

FIG. 25 is a diagram showing an example of the display of an output screen that displays measurement results.

FIG. 26 is a diagram showing an example of the display of an output screen that displays measurement results.

### DESCRIPTION OF EMBODIMENTS

Hereinafter, a plurality of embodiments of the invention will be described with reference to the drawings. In all drawings for describing each embodiment, the same members are generally given the same reference numerals, and repeated descriptions will be omitted. Further, in the following embodiments, the components (including element steps, and the like) are not necessarily essential, unless otherwise specified or considered to be obviously essential in principle. Furthermore, when “consists of A”, “constituted by A”, “has A”, and “includes A” are mentioned, other elements are not excluded, except when specifically specified to include only that element. Similarly, in the following embodiments, when referring to the shapes, positional relationships, and the like of components and the like, it includes those that are substantially close or similar to that shape and the like, except when specifically specified or considered to be obviously not essential in principle.

### Distance Measurement Device 10 According to First Embodiment of Invention

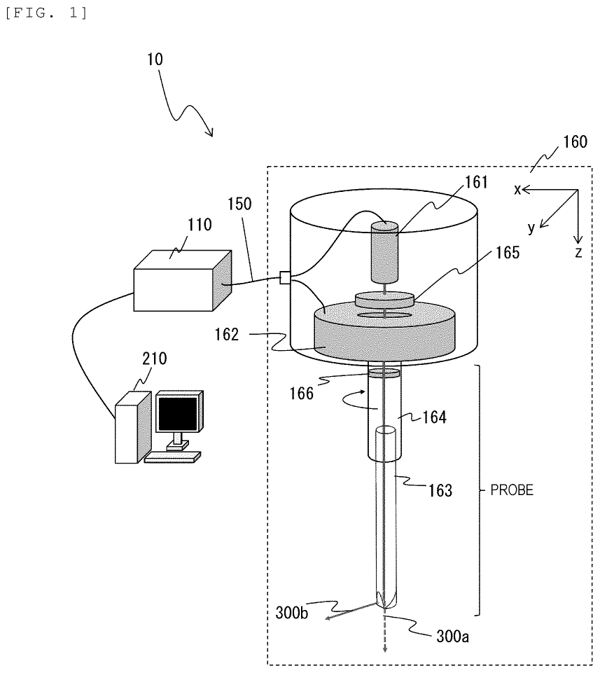

FIG. 1 is a schematic diagram showing a configuration example of a distance measurement device 10 according to a first embodiment of the invention. The distance measurement device 10 includes a distance measurement control mechanism 110, a measurement head 160, and an information processing device 210.

The distance measurement control mechanism 110 is connected to the measurement head 160 via a connection cable 150. The distance measurement control mechanism 110 generates measurement light and outputs it to the measurement head 160 via the connection cable 150. The distance measurement control mechanism 110 also converts the measurement light (reflected light) returned from the measurement head 160 into a predetermined electrical signal and outputs it to an information processing device 210.

The connection cable 150 is made of, for example, an optical fiber, and guides the measurement light output from the distance measurement control mechanism 110 to the measurement head 160.

The measurement head 160 irradiates the object T with the measurement light, receives the measurement light (reflected light) reflected by the object T, and outputs the received reflected light to the distance measurement control mechanism 110 via the connection cable 150.

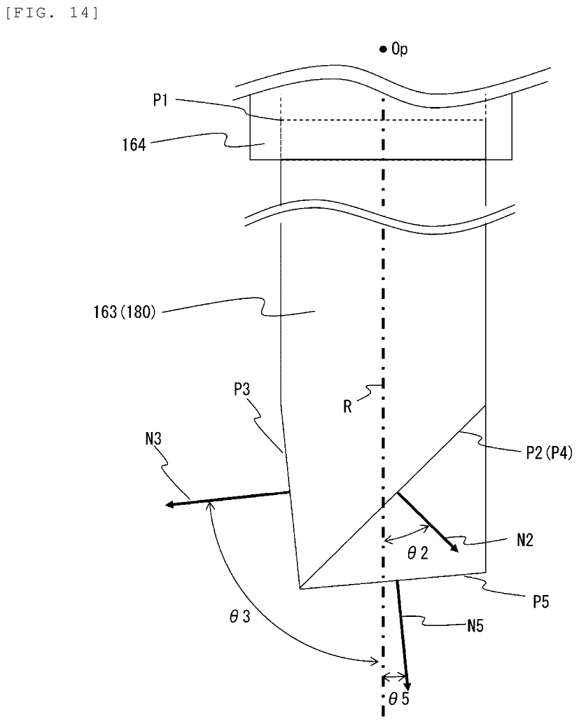

The distance measurement control mechanism 110 is also connected to the information processing device 210. The information processing device 210 is constituted by, for example, a general computer such as a personal computer. The information processing device 210 includes a distance calculation unit 261 (FIG. 12) that calculates a distance to the object T using a predetermined electrical signal input from the distance measurement control mechanism 110. The distance calculation unit 261 may include the distance measurement control mechanism 110. The information processing device 210 displays a calculation result of the distance to the object T on a display unit 250. The information processing device 210 may also be connected to the measurement head 160 so as to be able to communicate directly with it without going through the distance measurement control mechanism 110.

The measurement head 160 includes a lens unit 161, a rotation unit 162, an optical path switching element 163, a measurement head tip part 164, a first polarization state control unit 165, and a second polarization state control unit 166. The lens unit 161, the first polarization state control unit 165, and the second polarization state control unit 166 are equivalent to optical elements of the invention.

The lens unit 161 narrows the measurement light input from the distance measurement control mechanism 110 and guides it to the first polarization state control unit 165. The rotation unit 162 is constituted by a motor and the like. The rotation unit 162 rotates the motor and the like under the control of the distance calculation unit 261 (FIG. 12) of the information processing device 210, and simultaneously rotates the second polarization state control unit 166 and the optical path switching element 163 around a rotation axis parallel to the measurement light output from the lens unit 161.

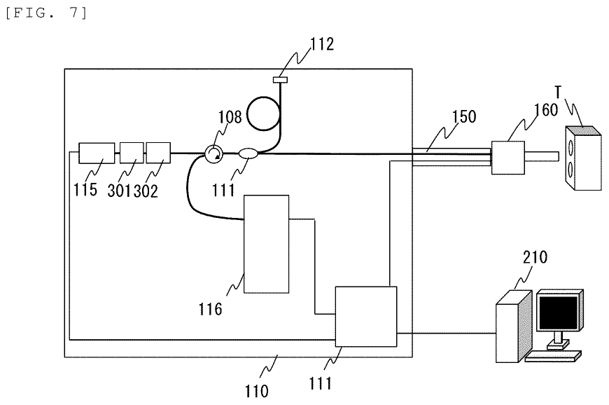

The optical path switching element 163 is constituted by, for example, a polarized beam splitter. The optical path switching element 163 selectively emits measurement light of which the circular polarization direction is controlled by a linear polarization switching element 302 (FIG. 5) and the first polarization state control unit 165, in accordance with the direction of polarization. Specifically, the optical path switching element 163 emits measurement light in at least one of a first direction 300a inclined at 90 degrees or less with respect to the moving direction of the measurement light output from the lens unit 161, and a second direction 300b that is substantially parallel to the xy plane.

The measurement head tip part 164 locks the second polarization state control unit 166 and the optical path switching element 163 with each other. The measurement head tip part 164 also transmits measurement light in a direction from the second polarization state control unit 166 to the optical path switching element 163 and reflected light directed from the optical path switching element 163 to the second polarization state control unit 166.

The measurement head tip part 164 has a structure through which light passes, and is formed, for example, in a hollow cylindrical shape with an opening in the first direction 300a. The measurement head tip part 164 may be formed, for example, in a cylindrical shape using a material with sufficient transmittance (for example, 90% or more) for a measurement light wavelength. The measurement head tip part 164 rotates around a rotation axis parallel to the measurement light output from the lens unit 161 as the rotation unit 162 rotates. Thereby, the second polarization state control unit 166 and the optical path switching element 163 that are locked by the measurement head tip part 164 also rotate together with the measurement head tip part 164. The measurement head tip part 164 is a portion ranging from the rotation point of the rotation unit 162 to the point where the optical path switching element 163 is locked. Hereinafter, the optical path switching element 163 and the measurement head tip part 164 will be collectively referred to as a probe.

The structure of the measurement head tip part 164 is not limited to the above example. For example, the measurement head tip part 164 may be configured such that the second polarization state control unit 166 and the optical path switching element 163 are locked using one or more supports, and the optical path switching element 163 rotates as the supports are driven. In addition, the measurement head tip part 164 may be constituted by, for example, a transparent two-layered tube, and may lock the second polarization state control unit 166 and the optical path switching element 163 using a tube on the inner layer side and rotate the second polarization state control unit 166 and the optical path switching element 163. In addition, the second polarization state control unit 166 and the optical path switching element 163 may be directly bonded to be locked to the measurement head tip part 164. The second polarization state control unit 166 and the optical path switching element 163 may be locked to the measurement head tip part 164 individually.

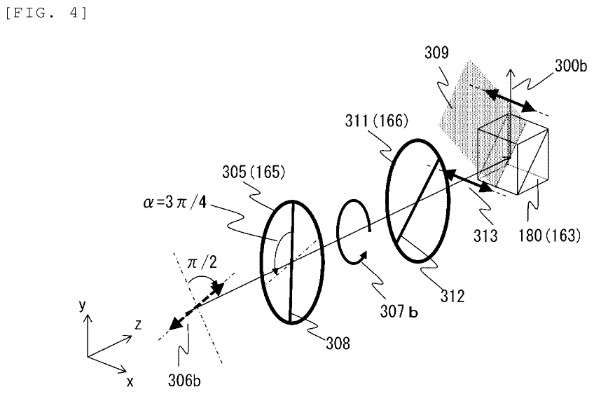

The first polarization state control unit 165 is fixed inside the measurement head 160 and does not rotate. The first polarization state e control unit 165 controls the polarization of the measurement light output from the distance measurement control mechanism 110 and changes, for example, the circular polarization direction of the measurement light. When a fiber-type polarization control element is used for the first polarization state control unit 165, it may be mounted in a stage before the lens unit 161. A configuration example of the first polarization state control unit 165 and detailed operations will be described later with reference to FIG. 3.

The second polarization state control unit 166 is constituted by, for example, a ¼ wavelength plate. As described above, the second polarization state control unit 166 is rotated together with the optical path switching element 163 as the measurement head tip part 164 is rotated by the rotation unit 162. The second polarization state control unit 166 outputs the polarization state of the measurement light controlled by the first polarization state control unit 165 to the optical path switching element 163 while maintaining a constant state with respect to the optical path switching element 163.

In the distance measurement device 10, the measurement light generated by the distance measurement control mechanism 110 is output to the measurement head 160. In the measurement head 160, the polarization of the measurement light is controlled by the first polarization state control unit 165, the polarization of the measurement light is controlled again by the second polarization state control unit 166, and the measurement light is emitted in the first direction 300a or the second direction 300b by the optical path switching element 163 in accordance with its polarization.

The measurement light emitted from the optical path switching element 163 is reflected or scattered by the object T. Then, the reflected or scattered light moves along a path opposite to when the measurement light is emitted, that is, in the order of the optical path switching element 163, the second polarization state control unit 166, the first polarization state control unit 165, the lens unit 161, and the connection cable 150, and returns to the distance measurement control mechanism 110.

The distance measurement control mechanism 110 converts the returned reflected light into a predetermined electrical signal and outputs it to the information processing device 210. The information processing device 210 calculates a distance to the object T on the basis of the predetermined electrical signal from the distance measurement control mechanism 110.

For example, when the shape of a cylindrical hole formed in the object T is measured, the depth to the bottom of the hole can be measured by using the measurement light emitted in the first direction 300a. In addition, a distance to the side surface of the hole can be measured by using the measurement light emitted in the second direction 300b.

### <Operation of Optical Path Switching Element 163>

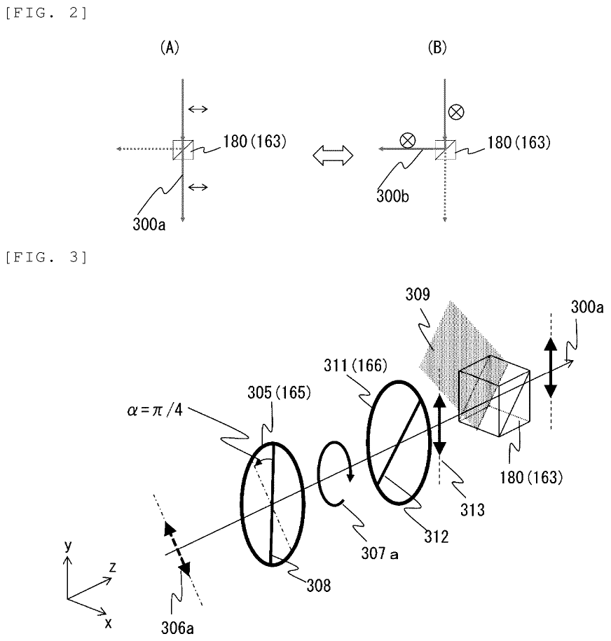

Next, the operation of the optical path switching element 163 will be described. FIG. 2 is a diagram showing the operation when a polarized beam splitter 180 is used for the optical path switching element 163.

FIG. 2(A) shows a state in which linearly polarized measurement light is vibrating in the right-left direction of the drawing. In this state, the measurement light incident on the polarized beam splitter 180 passes through a reflecting surface of the polarized beam splitter 180 and moves in the first direction 300a. Reflected light reflected by the object T moves back along the same path and returns to the distance measurement control mechanism 110.

FIG. 2(B) shows a state in which linearly polarized measurement light is vibrating in the depth direction of the drawing (direction perpendicular to the drawing). In this state, measurement light incident on the polarized beam splitter 180 is reflected by the reflecting surface of the polarized beam splitter 180 and moves in the second direction 300b. The reflected light reflected by the object T moves back along the same path and returns to the distance measurement control mechanism 110.

When controlling the polarization state of the measurement light to maintain a predetermined angle with respect to the optical path switching element 163 by using the properties of the linearly polarized light and the optical path switching element 163 as shown in the drawing, the moving direction of the measurement light can be maintained in the first direction 300a or the second direction 300b. That is, by controlling the polarization of the measurement light, the moving direction of the measurement light can be switched to the first direction 300a or the second direction 300b.

The polarization of the measurement light can be controlled by a polarization stabilization unit 301 (FIG. 5), the linear polarization switching element 302 (FIG. 5), the first polarization state control unit 165 (FIG. 1), and the second polarization state control unit 166 (FIG. 1).

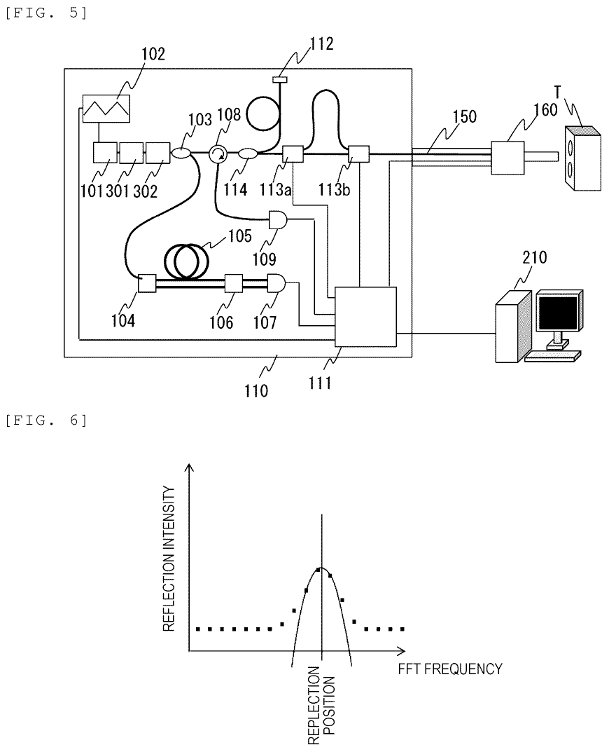

Next, FIGS. 3 and 4 are diagrams showing a relationship between the first polarization state control unit 165, the second polarization state control unit 166, and the optical path switching element 163. However, in FIGS. 3 and 4, a ¼ wavelength plate 305 is adopted for the first polarization state control unit 165, a ¼ wavelength plate 311 is adopted for the second polarization state control unit 166, and the polarized beam splitter 180 is adopted for the optical path switching element 163.

When the optical axis of the ¼ wavelength plate 305 is taken as a reference, and an angle α of the vibration direction of the linearly polarized measurement light incident on the ¼ wavelength plate 305 is π/4 as shown in FIG. 3, the measurement light emitted from the ¼ wavelength plate 305 is in a circularly polarized state (left circularly polarized light) 307a in which the measurement light rotates clockwise when viewed in the moving direction.

In addition, as shown in FIG. 4, when the angle α of the vibration direction the linearly polarized of measurement light incident on the ¼ wavelength plate 305 is 3η/4, the measurement light emitted from the ¼ wavelength plate 305 is in a circularly polarized state (right circularly polarized light) 307b in which the measurement light rotates counterclockwise when viewed in the moving direction.

In general, when circularly polarized light is incident on a ¼ wavelength plate, the ¼ wavelength plate has a property of emitting linearly polarized light that oscillates in a direction corresponding to the rotation direction of the circularly polarized light. Thus, as shown in FIG. 3, when the left circularly polarized light 307a is incident on the ¼ wavelength plate 311, linearly polarized light having an angle of π/4 with respect to the optical axis of the ¼ wavelength plate 311 is emitted. In addition, as shown in FIG. 4, when the right circularly polarized light 307b is incident on the ¼ wavelength plate 311, linearly polarized light having an angle of 3π/4 with respect to the optical axis of the ¼ wavelength plate 311 is emitted.

The polarized beam splitter 180 disposed at a rear stage of the ¼ wavelength plate 311 transmits linearly polarized light of which the vibration direction is parallel to an incident surface 309. That is, the polarized beam splitter 180 emits linearly polarized light of which the vibration direction is parallel to the incident surface 309 in the first direction 300a. The polarized beam splitter 180 also reflects the linearly polarized light of which the vibration direction forms an angle of π/2 with respect to the incident surface 309. That is, the polarized beam splitter 180 emits linearly polarized light of which the vibration direction forms an angle of π/2 with respect to the incident surface 309 in the second direction 300b.

The ¼ wavelength plate 311 (second polarization state control unit 166) and the polarized beam splitter 180 (optical path switching element 163) are rotated by the rotation unit 162. Thus, when the ¼ wavelength plate 311 and the polarized beam splitter 180 are rotated while they are locked to the measurement head tip part 164 so that an angle between the optical axis of the ¼ wavelength plate 311 and the incident surface of the polarized beam splitter 180 is π/4, distance measurement using the measurement light moving in the first direction 300a and distance measurement using the measurement light moving in the second direction 300b can be realized.

Incidentally, the linear polarization switching element 302 (FIG. 5) switches the vibration direction of the linearly polarized measurement light incident on the ¼ wavelength plate 305. When no voltage is applied to the linear polarization switching element 302, the linear polarization switching element 302 adjusts the vibration direction of the linearly polarized measurement light incident on the ¼ wavelength plate 305 to a first measurement light vibration direction 306a as shown in FIG. 3. When a voltage is applied to the linear polarization switching element 302, the linear polarization switching element 302 adjusts the vibration direction of the linearly polarized measurement light incident on the ¼ wavelength plate 305 to a second measurement light vibration direction 306b as shown in FIG. 4. That is, by electrically controlling the switching of the linear polarization switching element 302, the measurement light can be emitted by switching from a direction of the measurement head tip part 164 in the first direction 300a or the second direction 300b.

For example, as shown in FIG. 3, when the measurement light is emitted in the first direction 300a, the application of a voltage to the linear polarization switching element 302 may be stopped such that a linearly polarized vibration direction of the measurement light becomes the first measurement light vibration direction 306a having an inclination of an angle of π/4 with respect to a main axis 308 of the ¼ wavelength plate A. Thereby, the measurement light is converted into a left handed circularly polarized state by a ¼ wavelength plate A305, and then converted into linearly polarized light that vibrates in parallel with the incident surface 309 of the polarized beam splitter 180 by the ¼ wavelength plate 311, and is output in the first direction 300a.

For example, as shown in FIG. 4, when the measurement light is emitted in the second direction 300b, a voltage may be applied to the linear polarization switching element 302 so that the linear polarization vibration direction of the measurement light becomes the second measurement light vibration direction 306b having an inclination of an angle of 3π/4 with respect to the main axis 308 of the ¼ wavelength plate A. As a result, the measurement light is converted to a right handed circularly polarized state by the ¼ wavelength plate A305, and then converted into linearly polarized light that vibrates perpendicularly to the incident surface 309 of the polarized beam splitter 180 by the ¼ wavelength plate 311, and is emitted in the second direction 300b.

Although an example in which the ¼ wavelength plate 305 is adopted in the first polarization state control unit 165 is shown in FIGS. 3 and 4, a liquid crystal element may be adopted in the first polarization state control unit 165. In this case, the first polarization state control unit 165 can change the polarization direction of measurement light to be output by controlling a voltage to be applied to the liquid crystal element as the first polarization state control unit 165 and controlling the optical rotation of the liquid crystal element.

In addition, a fiber-type polarization control element may be adopted in the first polarization state control unit 165. In this case, when a twist or pressure is applied to the fiber-type polarization control element as the first polarization state control unit 165, the polarization direction of the measurement light output from the first polarization state control unit 165 can be controlled by inducing birefringence.

### <First Configuration Example of Distance Measurement Control Mechanism 110>

Next, FIG. 5 shows a first configuration example of the distance measurement control mechanism 110.

In the first configuration example, frequency modulated continuous waves (FMCW) or swept-source optical coherence tomography (SS-OCT) (or wavelength-swept OCT) is adopted as a distance measurement method to measure a distance to the object T.

Basic principles of FMCW and SS-OCT are the same. FMCW is mainly used for long-distance measurements using a light source with a long coherence length. SS-OCT is mainly used for measuring fine structures using a light source with a short coherence length.

The first configuration example includes an oscillation unit 101, a light emitting unit 102, optical fiber couplers 103, 104, 106, and 114, an optical fiber 105, light receiving units 107 and 109, an optical circulator 108, a reference mirror 112, optical switches 113a and 113b, a distance measurement control mechanism control unit 111, a polarization stabilization unit 301, and a linear polarization switching element 302.

The oscillation unit 101 injects a triangular wave current into the light emitting unit 102 on the basis of a sweep waveform signal from the distance measurement control mechanism control unit 111 to modulate a drive current. The light emitting unit 102 generates frequency modulated (FM) light whose frequency is swept over time at a constant modulation speed using the modulated drive current, and outputs it to the polarization stabilization unit 301. The light emitting unit 102 may be configured as a semiconductor laser device with an external resonator, and the resonant wavelength of the light emitting unit 102 may be changed by a triangular wave control signal from the oscillation unit 101. Even in this case, the light emitting unit 102 can generate FM light whose frequency is swept over time.

The polarization stabilization unit 301 stabilizes the polarization state of the FM light input from the light emitting unit 102 to a linearly polarized state in a constant direction and outputs it to the linear polarization switching element 302. The linear polarization switching element 302 outputs the direction of linearly polarized light of the FM light input from the polarization stabilization unit 301 to the rear stage as it is by applying a voltage to the built-in liquid crystal element, or rotates the linearly polarized light by π/2 and outputs it to the rear stage. Since the polarization stabilization unit 301 and the linear polarization switching element 302 are used to output linearly polarized light with a desired vibration direction, a combination of a general polarization state analyzer and a polarization state generator can be adopted.

The light (linearly polarized light) output from the linear polarization switching element 302 is incident on the optical fiber coupler 103. The optical fiber coupler 103 splits the incident light into two beams. One of the split beams is incident on the optical fiber coupler 104 of the reference optical system. The optical fiber couplers 103, 104, and 114 may be, for example, polarized beam splitters.

The light incident on the optical fiber coupler 104 is split into two beams, one of which is given a predetermined optical path difference, and then combined by the optical fiber coupler 106 and received by the light receiving unit 107. The light receiving unit 107 functions as a Mach-Zehnder interferometer and detects a constant reference beat signal proportional to the optical path difference.

The other of the two beams split by the optical fiber coupler 103 is incident on the optical fiber coupler 114 by the optical circulator 108. The optical fiber coupler 114 splits the incident light into two beams. One of the two beams split by the optical fiber coupler 114 is reflected by the reference mirror 112 to become a reference beam. The other of the two beams split by the optical fiber coupler 114 is output to the measurement head 160 via the optical switches 113a and 113b and is emitted to the object T. Operations of the optical switches 113a and 113b will be described later. The reflected light (measurement light) reflected by the object T is returned to the distance measurement control mechanism 110 via the connection cable 150.

The measurement light returned to the distance measurement control mechanism 110 passes through the optical switches 113a and 113b, is combined with the reference light reflected by the reference mirror 112 by the optical fiber coupler 114, and is guided to the light receiving unit 109 by the optical circulator 108. The light receiving unit 109 a measurement detects beat signal generated by interference between the reference light and the measurement light.

The distance measurement control mechanism control unit 111 performs A/D conversion of the measurement beat signal detected by the light receiving unit 109 using the reference beat signal detected by the light receiving unit 107 with a sampling clock. Alternatively, the distance measurement control mechanism control unit 111 samples the reference beat signal and the measurement beat signal with a constant sampling clock.

More specifically, the distance measurement control mechanism control unit 111 creates a signal with a phase shift of π/2 by performing a Hilbert transform on the reference beat signal, obtains a local phase of the signal from the reference signal before and after the Hilbert transform, and interpolates this phase to obtain a timing at which the reference has a constant phase. Furthermore, the distance measurement control mechanism control unit 111 performs interpolation sampling of the measurement beat signal in accordance with this timing, thereby resampling the measurement signal on the basis of the reference signal.

Even when the distance measurement control mechanism control unit 111 samples a measurement signal using the reference beat signal as a sampling clock with a built-in AD/DA converter to perform A/D conversion, it is possible to obtain the same results.

Regarding the analysis of a beat signal, there is a time difference Δt between the timing at which the measurement light reaches the light receiving unit 109 and the timing at which the reference light reaches the light receiving unit 109, but the frequency of a light source changes during this time, and thus a measurement beat signal with a beat frequency fb equal to the resulting frequency difference is detected. When a frequency sweep width is Δν and a time required to modulate the frequency by the frequency sweep width Δν is T, a relationship shown in the following Formula (1) is established.

$$Δ t = ( T / 2 Δν ) {f}_{b} \qquad ( 1 )$$

A distance L to an object is half a distance by which light moves during the time difference Δt, and thus the distance L can be calculated by the following Formula (2) using the speed of light c in the atmosphere. As is apparent from Formula (2), the distance L and the beat frequency fb have a linear relationship.

$$L = ( cT / 2 Δν ) {f}_{b} \qquad ( 2 )$$

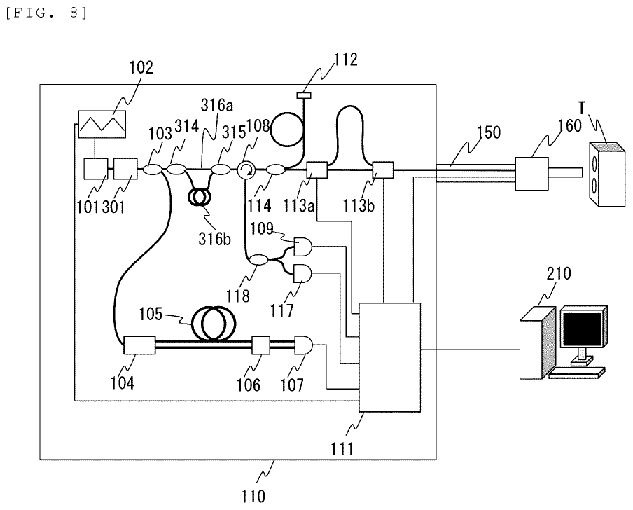

When a fast Fourier transform (FFT) is performed on a measurement signal obtained by the distance measurement control mechanism control unit 111, and a peak position and magnitude are obtained, a reflection position of the object T and the amount of reflected light can be known. For example, in an OCT device, it is desirable to visualize a scattering position and scattering magnitude of a semitransparent body such as a living body, and thus an amplitude spectrum of the FFT can be used as it is. In this embodiment, in order to accurately obtain the position of the surface of the object T, interpolation is performed as described with reference to FIG. 6 to improve a distance detection resolution.

FIG. 6 is a diagram showing an example of a method of obtaining a reflection position on the surface of the object T from a reflection intensity profile. In this drawing, the horizontal axis represents the frequency of the FFT, and the vertical axis represents a reflection intensity.

As shown in the drawing, data near the peak of the reflection intensity is discrete. A distance between points, that is, a distance resolution, is c/2Δν. In the case of SS-OCT, a general wavelength is 1300 nm, a sweep width is 100 nm, and a frequency sweep width Δν is 17.8 THz, and thus the distance resolution c/2Δν is 8.4 μm. In the case of FMCW, a general wavelength is 1500 nm, a sweep width is 2 nm, and a frequency sweep width Δν is 267 GHZ, and thus a distance resolution c/2Δν is 0.56 mm.

On the other hand, as shown in FIG. 6, when a function such as a quadratic function or a Gaussian function is applied using three or more points near the peak, and the values near the peak of the applied function are used for interpolation, it is possible to increase the resolution to approximately 1/10.

Returning back to FIG. 5, the optical switches 113a and 113b that constitute the distance measurement control mechanism 110 will be described. The optical switches 113a and 113b perform switching under the control of the distance measurement control mechanism control unit 111.

To obtain a beat signal by interference between the reference light and the measurement light, a difference between an optical path length from the optical fiber coupler 114 to the reference mirror 112 and an optical path length from the optical fiber coupler 114 to the object T needs to be equal to or less than a coherence length of the light emitting unit 102. To meet this condition, the optical switches 113a and 113b are switched simultaneously in accordance with a distance from the optical fiber coupler 114 to the object T, and the length of the optical fiber between the switches is changed.

In addition, when the difference between the optical path length from the optical fiber coupler 114 to the reference mirror 112 and the optical path length from the optical fiber coupler 114 to the object T is excessively large, that is, even when the coherence length is long, the beat frequency fb becomes too high and cannot be detected by the light receiving unit 109. For this reason, the optical switches 113a and 113b are switched simultaneously to change the length of the optical fiber between the switches so that the beat frequency fb becomes a frequency that can be detected by the light receiving unit 109.

In the first configuration example, the optical switches 113a and 113b switch between two optical fibers with different lengths, but three or more optical fibers with different lengths may be switched depending on the range of the object. In addition, the timing at which the optical switches 113a and 113b switch between the optical fibers may be fixed or may vary depending on a situation, such as a distance between the object T and the optical path switching element 163. For example, the optical switches 113a and 113b may be switched for each rotation in synchronization with the rotation of the optical path switching element 163.

Although the optical path has been described as using an optical fiber, first, light that propagates through a free space may be generated using an optical fiber collimator or the like, and the optical path length may be changed by switching the light with a mirror or the like or moving the mirror.

Furthermore, an optical switch similar to the optical switches 113a and 113b may be provided in the optical path between the optical fiber coupler 114 used for branching and the reference mirror 112 to switch the length of the optical fiber.

In the first configuration example, the optical paths from the optical fiber coupler 114 to the optical switch 113b are installed inside the distance measurement control mechanism 110, but these optical paths may be installed inside the measurement head 160 instead of inside the distance measurement control mechanism 110.

In addition, a distance measurement method performed using the distance measurement control mechanism 110 is not limited to the above-described example. For example, a method of irradiating the object T with pulse or burst-like light and measuring a time until the pulse or burst is received, such as like a time of flight (TOF) method, a Phase Shift method, or a method of irradiating the object T with continuously intensity-modulated light and measuring the phase of a received signal, such as an optical comb distance measurement method, can be used. In addition, a distance may be measured by measuring a focus shift, and a white light confocal method, an astigmatism method, a knife edge method, and a conoscopic holography method can be adopted.

### Second Configuration Example of Distance Measurement Control Mechanism 110

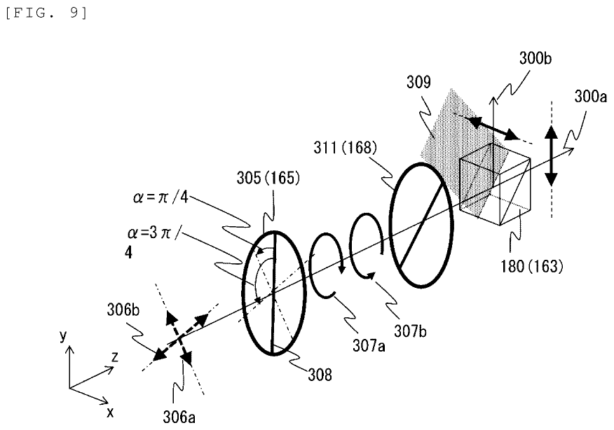

Next, FIG. 7 shows a second configuration example of the distance measurement control mechanism 110. In the second configuration example, spectral domain-optical coherence tomography (SD-OCT) (or frequency domain OCT) is adopted as a distance measurement method to measure a distance to an object T.

The second configuration example includes the optical circulator 108, the optical fiber coupler 114, the reference mirror 112, the distance measurement control mechanism control unit 111, a broadband light emitting unit 115, a spectrometer 116, a polarization stabilization unit 301, and a linear polarization switching element 302. Among the components of the second configuration example, the components that are common to the first configuration example (FIG. 5) are given the same reference numerals, and thus the description thereof will be omitted as appropriate.

The broadband light emitting unit 115 generates broadband light as measurement light under the control of the distance measurement control mechanism control unit 111. The generated measurement light reaches the optical circulator 108 via the polarization stabilization unit 301 and the linear polarization switching element 302, and is guided to the optical fiber coupler 114 by the optical circulator 108 and split into two beams. One of the split beams of the measurement light is emitted to the object T via the measurement head 160. The other of the split beams of the measurement lights is reflected by the reference mirror 112 and becomes reference light.

The measurement light reflected by the object T returns to the distance measurement control mechanism 110 via the measurement head 160, is combined with the reference light by the optical fiber coupler 114, and is guided to the spectrometer 116 by the optical circulator 108, whereby a spectral spectrum is analyzed.

The spectral spectrum shows vibrations of a frequency proportional to a difference in the optical path length between the object T and the reference mirror 112. For this reason, the distance measurement control mechanism control unit 111 in the second configuration example realizes distance measurement of the object T by analyzing this frequency.

### Third Configuration Example of Distance Measurement Control Mechanism 110

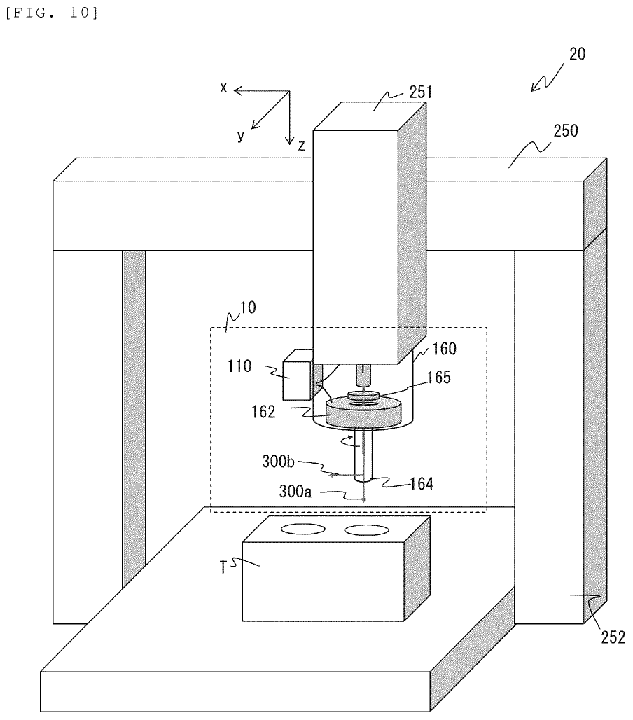

Next, FIG. 8 shows a third configuration example of the distance measurement control mechanism 110. In this third configuration example, measurement light can be emitted from the measurement head tip part 164 of the measurement head 160 simultaneously in both the first direction 300a and the second direction 300b without switching between the directions.

In the third configuration example, similarly to the first configuration example (FIG. 5), FMCW or SS-OCT (or wavelength swept OCT) is adopted as a distance measurement method to measure a distance to the object T.

Among the components of the third configuration example, the components that are common to the first configuration example (FIG. 5) are given the same reference numerals, and the description thereof will be omitted as appropriate.

In the third configuration example, the linear polarization switching element 302 is omitted from the first configuration example (FIG. 5), optical fiber couplers 314 and 315 and optical fibers 316a and 316b are added between the optical fiber coupler 103 and the optical circulator 108, and a light receiving unit 117 and an optical fiber coupler 118 are added to the rear stage of the optical circulator 108.

The optical fiber coupler 314 splits light into two beams, in which the light is output from the polarization stabilization unit 301, is input via the optical fiber coupler 103, and is in a stabilized linear polarization state in a certain direction.

The optical fiber 316a outputs one of the two beams split by the optical fiber coupler 314 to the optical fiber coupler 315 while maintaining its linear polarization state.

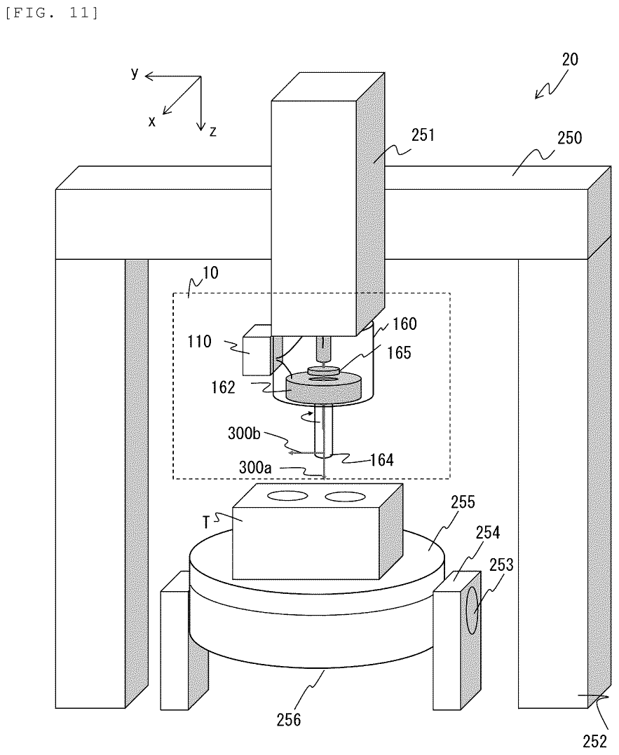

The length of the optical fiber 316b is adjusted such that a difference between the length of the optical fiber 316b and the length of the optical fiber 316a is larger than a coherence length of the measurement light. Thereby, it is possible to prevent interference between the left circularly polarized light 307a and the right circularly polarized light 307b (FIG. 9) that are simultaneously output from the first polarization state control unit 165.

In addition, the optical fiber 316b is connected to the optical fiber coupler 315 in a state where it is physically twisted by π/2 compared to the optical fiber 316a. Thereby, light beams with mutually orthogonal linear polarization states are incident on the optical fiber coupler 315 via the optical fibers 316a and 316b.

The optical fiber coupler 315 combines the light beams with mutually orthogonal linear polarization states and outputs it to the optical circulator 108. The optical fiber coupler 118 splits combined light of the reference light and the measurement light, which is incident from the optical circulator 108, into two beams, outputs one of the beams to the light receiving unit 109, and outputs the other to the light receiving unit 117.

The light receiving unit 109 corresponds to reflected light from the first direction 300a (FIG. 1) and detects a constant reference beat signal proportional to an optical path difference. The light receiving unit 117 corresponds to reflected light from the second direction 300b (FIG. 1) and detects a constant reference beat signal proportional to an optical path difference.

Next, FIG. 9 is a diagram showing a relationship between the first polarization state control unit 165, the second polarization state control unit 166, and the optical path switching element 163 in the third configuration example of the distance measurement control mechanism 110. However, in this drawing, as in FIGS. 3 and 4, the ¼ wavelength plate 305 is adopted for the first polarization state control unit 165, the ¼ wavelength plate 311 is adopted for the second polarization state control unit 166, and the polarized beam splitter 180 is adopted for the optical path switching element 163.

When the optical axis of the ¼ wavelength plate 305 is used as a reference, and measurement light with mutually orthogonal linear polarization states are incident on the ¼ wavelength plate 305 as shown in the drawing, the ¼ wavelength plate 305 simultaneously emits the circular polarization state (left circularly polarized light) 307a that rotates clockwise when viewed in the moving direction from the ¼ wavelength plate 305 and the circular polarization state (right circularly polarized light) 307b that rotates counterclockwise.

Next, the ¼ wavelength plate 311 emits linearly polarized light with an angle of π/4 with respect to the optical axis of the ¼ wavelength plate 311 in response to the incident left circularly polarized light 307a. In addition, linearly polarized light with an angle of 3π/4 with respect to the optical axis of the ¼ wavelength plate 311 is emitted in response to the right circularly polarized light 307b that is incident at the same time as the left circularly polarized light 307a.

The polarized beam splitter 180 disposed at the rear stage of the ¼ wavelength plate 311 transmits linearly polarized light whose vibration direction is parallel to the incident surface 309, that is, emits it in the first direction 300a. The polarized beam splitter 180 also reflects the linearly polarized light whose vibration direction forms an angle of π/2 with respect to the incident surface 309, which is incident at the same time, that is, emits it in the second direction 300b.

Thus, the third configuration example of the distance measurement control mechanism 110 can emit measurement light simultaneously in both the first direction 300a and the second direction 300b from the measurement head tip part 164 of the measurement head 160 without switching between the first direction 300a and the second direction 300b. Then, the distance measurement control mechanism control unit 111 can calculate distances to the object T in both the first direction 300a and the second direction 300b substantially at the same time.

### Other Configuration Examples of Distance Measurement Control Mechanism 110

In the first configuration example (FIG. 5) and the third configuration example (FIG. 8) of the distance measurement control mechanism 110 described above, FMCW or SS-OCT is adopted as a distance measurement method, while in the second configuration example (FIG. 7), SD-OCT is adopted as a distance measurement method.

Another distance measurement method that can be adopted by the distance measurement control mechanism 110 is, for example, a white light confocal method.

Although not shown in the drawing, the configuration example of the distance measurement control mechanism 110 adopting the white light confocal method is different from the second configuration example (FIG. 7) in that the reference mirror 112 and the optical fiber coupler 114 are omitted. Instead, a configuration in which chromatic aberration is intentionally generated is adopted for a lens unit 161 of the measurement head 160, and the measurement head 160 whose focal position varies depending on the wavelength of measurement light is used.

In the configuration example, light reflected or scattered by the object T is refocused by the lens unit 161, and when the light returns to the distance measurement control mechanism 110, only the wavelength that is in focus at a distance to the object T is captured. That is, when this light is detected by a spectrometer 116 and a wavelength at which a spectrum peaks is calculated by the distance measurement control mechanism control unit 111, the distance to the object T can be measured. According to this configuration example, detected spectral data itself can be obtained as the data shown in FIG. 6 without performing FFT on measurement light.

### Configuration Example of Shape Measurement Device 20 Adopting Distance Measurement Device 10

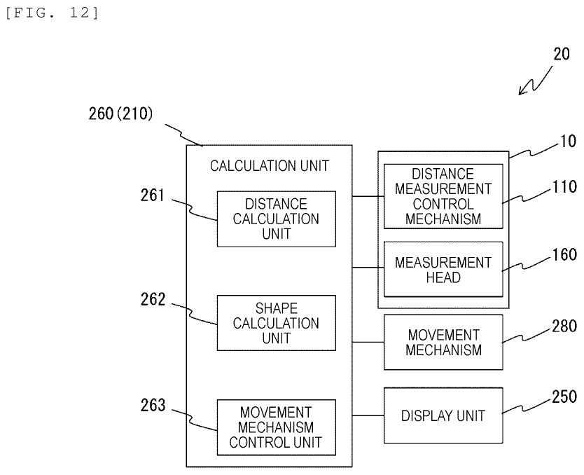

Next, FIG. 10 is a schematic diagram showing a configuration example of the shape measurement device 20 adopting the distance measurement device 10. The shape measurement device 20 measures a three-dimensional shape of an object T.

The shape measurement device 20 includes a movement mechanism 280 (FIG. 12) including an xz-axis movement mechanism 251 and a y-axis movement mechanism 252.

The distance measurement device 10 including the measurement head 160 is installed in the xz-axis movement mechanism 251. The xz-axis movement mechanism 251 can move in the x-axis direction and the z-axis direction. The measurement head tip part 164 of the measurement head 160 also moves in association with the movement of the xz-axis movement mechanism 251.

The y-axis movement mechanism 252 is a gate-shaped structure that can move in the y-axis direction. The y-axis movement mechanism 252 supports the xz-axis movement mechanism 251, and as the y-axis movement mechanism 252 moves, the measurement head tip part 164 of the measurement head 160 supported by the xz-axis movement mechanism 251 also moves. Thus, the xz-axis movement mechanism 251 and the y-axis movement mechanism 252 can control the posture of the object T with three degrees of freedom.

The configuration of the movement mechanism is not limited to the above description, and the movement mechanism can be anything as long as it can move the measurement head tip part 164 in three axial directions. For example, the distance measurement control mechanism 110 may not be installed in the xz-axis movement mechanism 251, and only the measurement head 160 may be installed in the xz-axis movement mechanism 251, thereby allowing the measurement head tip part 164 to move in three axial directions.

The shape measurement device 20 has a general axis configuration used in three-dimensional measurement devices, but the measurement head 160 of the distance measurement device 10 can be installed instead of a measurement head of the three-dimensional measurement device, and thus it is possible to realize highly functional non-contact shape measurement.

Further, in general three-axis machining devices, a Z axis is set on a tool side and an x-axis and a y-axis are set on an object T side in many cases, and the configuration is different from that of the shape measurement device 20 shown in FIG. 10. However, when the measurement head 160 is installed on the three-axis machining device, it is possible to realize on-machine measurement on the machining device.

Further, when the measurement head 160 is installed on a multi-degree-of-freedom robot and the measurement head tip part 164 is made movable, it is possible to realize the shape measurement device 20 that makes it possible to perform measurement with a higher degree of freedom.

### Another Configuration Examples of Shape Measurement Device Using Distance Measurement Device 10

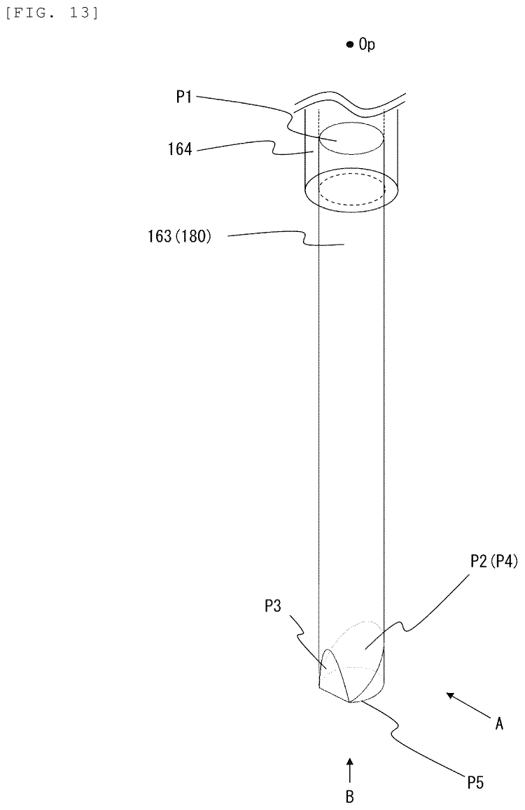

Next, FIG. 11 is a schematic diagram showing another configuration example of the shape measurement device 20 using the distance measurement device 10. This configuration example is obtained by adding a rotation mechanism 256 to the configuration example shown in FIG. 10. That is, in this configuration example, the shape measurement device 20 includes the movement mechanism 280 including the xz-axis movement mechanism 251, the y-axis movement mechanism 252, and the rotation mechanism 256.

The rotation mechanism 256 is locked by a rotation axis 253 supported by a structure 254 and rotates around the rotation axis 253 parallel to the xy plane. In addition, the rotation mechanism 256 rotates around a rotation axis (not shown) that is perpendicular to the rotation axis 253 and parallel to the z axis.

A sample stage 255 is installed on the rotation mechanism 256, and the sample stage 255 rotates in association with the rotation of the rotation mechanism 256. Thereby, an object T placed on the sample stage 255 also rotates. Thus, the rotation mechanism 256 can control the posture of the object T with two degrees of freedom.

That is, in this configuration example, it is possible to control a relative position between the measurement head 160 and the object T with two degrees of freedom by using the rotation mechanism 256 in addition to being able to control the relative position with three degrees of freedom by using the xz-axis movement mechanism 251 and the y-axis movement mechanism 252, making it possible to control a total of five degrees of freedom. Thereby, any part of the object T can be measured from any direction.

In a general 5-axis machining tool, it is possible to realize on-machine measurement on the machining tool by installing the measurement head 160. In addition, since the number of degrees of freedom and a configuration vary depending on a machining tool, the configuration example of the shape measurement device 20 is not limited to those shown in FIGS. 10 and 11.

### Configuration Example of Functional Blocks of Shape Measurement Device 20

Next, FIG. 12 shows a configuration example of the functional blocks of the shape measurement device 20. The shape measurement device 20 includes a calculation unit 260, the distance measurement control mechanism 110, the measurement head 160, the display unit 250, and the movement mechanism 280.

The distance measurement control mechanism 110 and the measurement head 160 are equivalent to the distance measurement device 10. The calculation unit 260 is equivalent to the information processing device 210.

The calculation unit 260 controls the overall shape measurement device 20. The calculation unit 260 includes the distance calculation unit 261, a shape calculation unit 262, and a movement mechanism control unit 263.

The distance calculation unit 261 analyzes a measurement beat signal and a reference beat signal captured by the distance measurement control mechanism 110, converts them into distances, and outputs them to the shape calculation unit 262 together with the emission direction of measurement light. The distance calculation unit 261 also controls the measurement head 160 and controls the rotation angle of the measurement head tip part 164.

The shape calculation unit 262 measures the shape of the object T on the basis of the distance input from the distance calculation unit 261 and the emission direction of the measurement light. The shape calculation unit 262 displays the measured shape of the object T on the display unit 250.

The movement mechanism control unit 263 controls the movement mechanism 280 and controls a relative position between the measurement head 160 and the object T. The distance calculation unit 261 is notified of the position and posture of the object T controlled by the movement mechanism control unit 263. The calculation unit 260 may be installed in the distance measurement control mechanism 110 or the measurement head 160. The display unit 250 is constituted by a display device and displays measurement results.

### First Configuration Example of Optical Path Switching Element 163

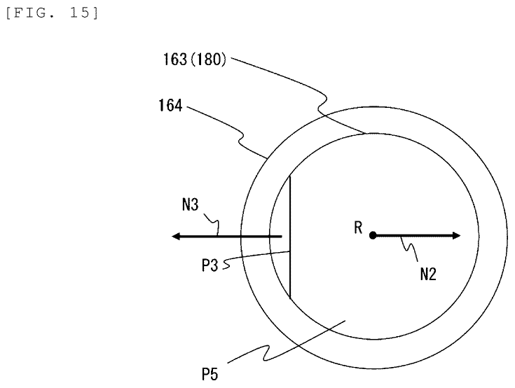

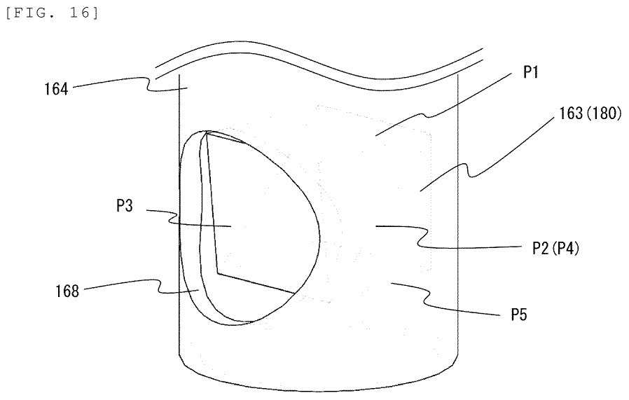

Next, FIG. 13 shows a first configuration example of the optical path switching element 163. In this first configuration example, the polarized beam splitter 180 is adopted for the optical path switching element 163. FIG. 14 is an arrow view of a tip part of the optical path switching element 163 (polarized beam splitter 180) when viewed from the direction of an arrow A shown in FIG. 13. FIG. 15 is an arrow view of the tip part of the optical path switching element 163 (polarized beam splitter 180) when viewed from the direction of an arrow B shown in FIG. 13. FIGS. 14 and 15 show an angular relationship between surfaces that constitute the polarized beam splitter 180 as the optical path switching element 163.

As shown in FIG. 13, the polarized beam splitter 180 has a first surface P1 at the upper end that is locked by the measurement head tip part 164, a fifth surface P5 on the tip side, a second surface P2 above a fifth surface P5 on the tip side, and a third surface P3 on the side surface on the tip side. The polarized beam splitter 180 is constituted by a first transmissive member having the first surface P1, the second surface P2, and the third surface P3, and a second transmissive member having the fourth surface P4 and the fifth surface P5, and is formed such that the second surface of the first transmissive member and the fourth surface of the second transmissive member are in contact with each other.

The polarized beam splitter 180 in this first configuration example is locked by the hollow measurement head tip part 164 so that the fifth surface P5 and the third surface P3 are exposed.

As shown in FIG. 14, the fifth surface P5 of the polarized beam splitter 180 is an emission surface of the measurement light in the first direction 300a (FIG. 1). A normal vector N5 of the fifth surface P5 is not parallel to a rotation axis R. An angle θ5 between the normal vector N5 and the rotation axis R is in a range between greater than 0 degrees and less than 45 degrees, for example, 1 degree.

The third surface P3 of the polarized beam splitter 180 is formed in a partially elliptical shape. The third surface P3 is an emission surface of measurement light in the second direction 300b (FIG. 1). An angle θ3 between the normal vector N3 of the third surface P3 and the rotation axis R is in a range between greater than 0 degrees and less than 90 degrees, for example, 84 degrees.

The second surface P2 of the polarized beam splitter 180, which serves as a deposition surface that reflects the measurement light in the direction of the third surface P3, is also referred to as the fourth surface P4. An angle θ2 between a normal vector N2 of the second surface P2 and the rotation axis R is in a range between greater than 45 degrees and less than 90 degrees, for example, 46 degrees.

The polarized beam splitter 180 of the first configuration example may have a circular shape when viewed from the direction of the arrow B (FIG. 13), or may have a shape in which a part of a circle is missing as shown in FIG. 15. The polarized beam splitter 180 serving as the optical path switching element 163 shown in FIGS. 13 to 15 is smaller than a general optical path switching element constituted by a substantially hexahedron, and can be used to measure holes with smaller diameters.

Furthermore, the surfaces other than the first surface P1 to the fifth surface P5 constituting the polarized beam splitter 180 may be of any shape, and may have, for example, a cylindrical shape as shown in FIG. 13.

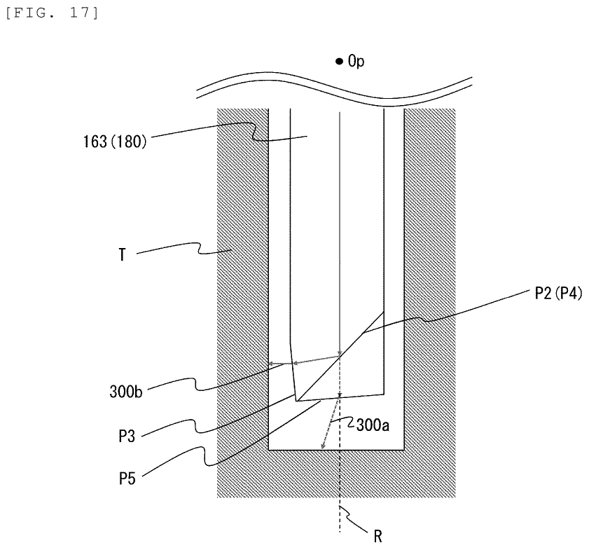

Next, FIG. 16 shows a modification example of the first configuration example of the optical path switching element 163. The optical path switching element 163 may be configured such that all surfaces thereof are substantially flat, as shown in the drawing, for example, depending on the purpose of ensuring the accuracy of manufacturing.

In addition, when the measurement head tip part 164 can be inserted while maintaining a sufficient distance with respect to the internal shape of the hole of the object T to be able to perform measurement, a configuration may be adopted as shown in the drawing so that a dimension between the first surface P1 and the second surface P2 of the optical path switching element 163 is further reduced, an opening 168 is provided in the measurement head tip part 164 to lock the optical path switching element 163 in order to perform measurement in the second direction 300b (FIG. 1), and the measurement head tip part 164 is inserted into the hole of the object T.

This modification example shows a state where the optical path switching element 163 is covered by the measurement head tip part 164 provided with the opening 168. However, the optical path switching element 163 may be locked such that at least a part of the third surface P3 of the optical path switching element 163 is exposed to the measurement head tip part 164 not provided with the opening 168, or the optical path switching element 163 may be covered by a cap-shaped transparent part.

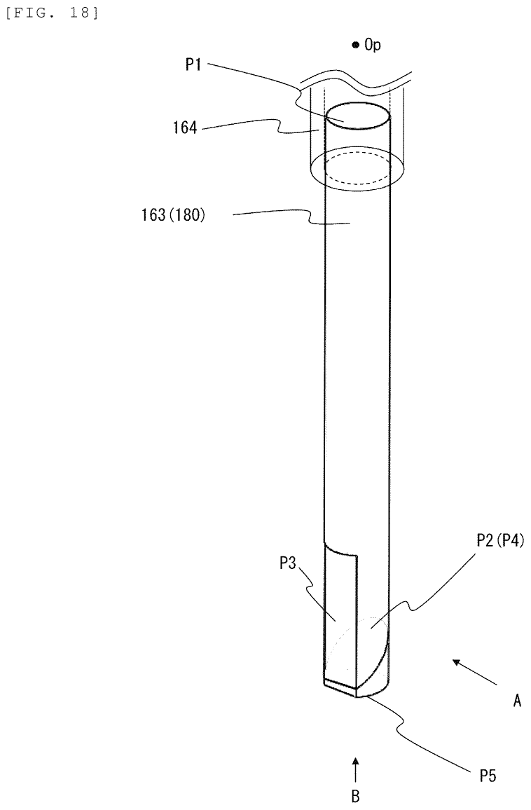

Next, FIG. 17 shows an optical path in the first configuration example of the optical path switching element 163.

In the first configuration example, measurement light moving in the first direction 300a is emitted in a state of being inclined with respect to the rotation n axis R in accordance with an inclination θ5 of the fifth surface P5 and a relative refractive index of the optical path switching element 163 under the control of the linear polarization switching element 302.

Reflected light that passes through the second surface P2, is reflected by the fifth surface P5, and returns upward is inclined at an angle twice the angle θ5 (2 degrees in this case) with respect to the rotation axis R. For this reason, the amount of reflected light detected on the fifth surface P5 is reduced compared to when the fifth surface P5 is not inclined, and measurement noise can be reduced.

On the other hand, measurement light that moves in the second direction 300b is emitted at an angle according to the relative refractive index of the optical path switching element 163 and the angle of incidence on the third surface P3 under the control of the linear polarization switching element 302. At this time, the second direction 300b can be made substantially perpendicular to the rotation axis R by maintaining a relationship of the following Formula (3) for the angles θ2 and θ3 on the basis of Snell's law, a relative refractive index n of a region of the optical path switching element 163 which is constituted by the first surface P1, the second surface P2, and the third surface P3, and a geometric relationship.

$$( 90 - θ3 ) = ( 2 n / n - 1 ) ( θ2 - 45 ) \qquad ( 3 )$$

However, even when the measurement light is emitted in the second direction 300b under the control of the linear polarization switching element 302, a part of the measurement light may move in the direction of the fifth surface P5 and be reflected at the fifth surface P5 due to a relationship of a polarization extinction ratio of an optical element to be used. Even in this case, the amount of detected light is reduced as in the case where the measurement light moving in the first direction 300a is reflected at the fifth surface P5, and thus measurement noise can be reduced.

Furthermore, the moving direction of the reflected light reflected laterally at the second surface (film formation surface) P2 and reflected at the third surface P3 also maintains an angle of 360−4×θ2−2×θ3 with respect to the rotation axis R, that is, when θ2=46 and θ3=84, the reflected light has an angle of 8 degrees. For this reason, compared to when the third surface P3 is not inclined, the amount of detected light of the reflected light generated at the third surface P3 is reduced, so that the measurement noise can be reduced.

In general, in order to accurately measure the inner diameter of a precisely machined hole, it is desirable to align the axis of the hole with the rotation axis R and to align the normal vector of the surface of the object T with the direction of the measurement light moving in the second direction 300b. However, in such a case, the normal vectors of the third surface P3 of the optical path switching element 163 and the surface of the object T tend to align with each other, which may cause multiple reflections between the third surface P3 and the surface of the object T, resulting in a concern of measurement noise.

Consequently, in this embodiment, an angular relationship shown in Formula (3) is maintained. Thereby, while the normal vector of the surface of the object Tis made to align with the direction of the measurement light moving in the second direction 300b, the normal vector of the third surface P3 and the normal vector of the surface of the object T can be inclined without being made to align with each other.

Multiple reflection light generated between the third surface P3 and the surface of the object T is incident on the optical path switching element 163 again with an inclination with respect to the optical axis of the measurement light input from the lens unit 161 and reflected laterally at the deposition surface P2, and thus the surface of the object T can be appropriately irradiated with the measurement light while reducing measurement noise caused by the multiple reflection light.

At this time, for the purpose of further reducing the measurement noise that may occur when the reflected light on the surface of the object T is reflected by the outer surface of the optical path switching element 163, the cylindrical outer surface of the optical path switching element 163 and the inner surface of the measurement head tip part 164 may be processed into a sanded surface or painted black.

The surfaces constituting the optical path switching element 163 may be subjected to anti-reflection coating for the purpose of reducing a loss of irradiated light intensity and measurement noise. The surfaces constituting the optical path switching element 163 may be subjected to water-repellent coating for the purpose of preventing an increase in reflectance due to contamination of the surfaces.

In addition, a distance from a predetermined origin Op to the first surface P1 is measured by detecting reflected light of measurement light on the first surface P1 at the same time as measuring a distance to the surface of the object T, and thus it is possible to grasp fluctuations in the optical path lengths of the measurement head tip part 164 and the optical system in the front stage and to correct results of the measurement of the distance to the surface of the object T. In this case, the first surface P1 may be partially subjected to partial reflection coating in order to obtain a desired reflected light intensity.

### Second Configuration Example of Optical Path Switching Element 163

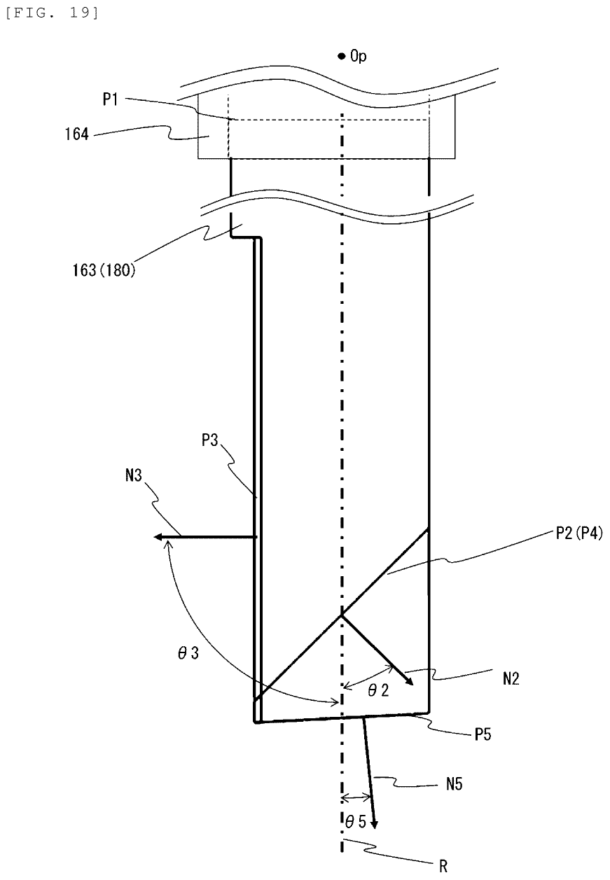

Next, FIG. 18 shows a second configuration example of the optical path switching element 163. In the second configuration example, similarly to the first configuration example (FIG. 13), the polarized beam splitter 180 is adopted as the optical path switching element 163. The second configuration example differs from the first configuration example (FIG. 13) in the shape of the third surface P3. In the second configuration example, the third surface of the polarized beam splitter 180 is formed in a rectangular shape.

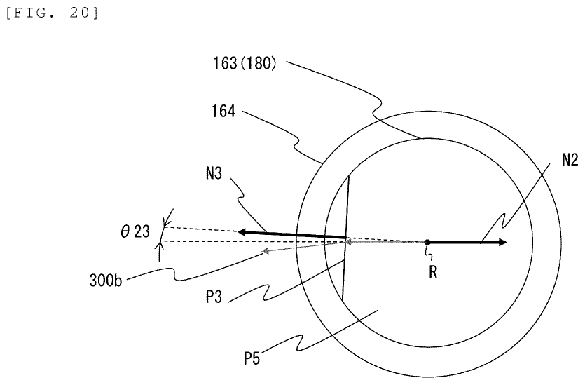

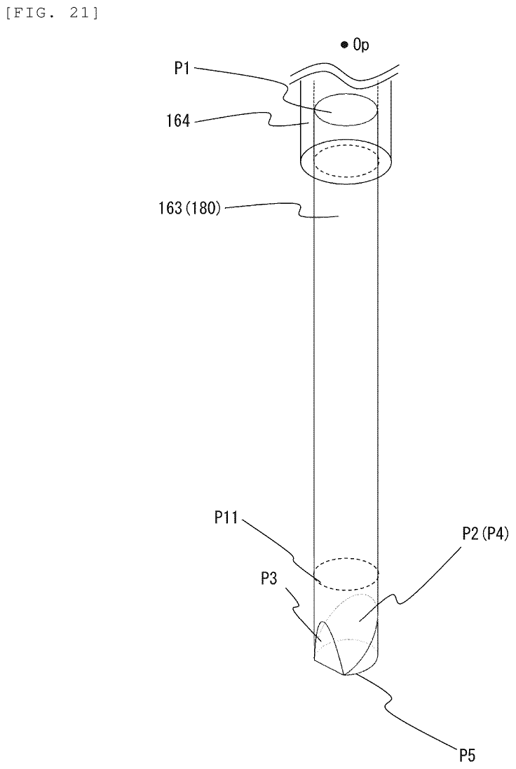

FIG. 19 is an arrow view of a tip part of the optical path switching element 163 when viewed from the direction of an arrow A shown in FIG. 18. FIG. 20 is an arrow view of the tip part of the optical path switching element 163 when viewed from the direction of an arrow B shown in FIG. 18. FIGS. 19 and 20 show an angular relationship between surfaces that constitute the polarized beam splitter 180 as the optical path switching element 163.

As shown in FIG. 19, the fifth surface P5 of the polarized beam splitter 180 is an emission surface in the first direction 300a. The normal vector N5 of the fifth surface P5 and the rotation axis R are not parallel to each other. An angle θ5 between the normal vector N5 and the rotation axis R is in a range between greater than 0 degrees and 90 degrees, for example 1 degree.

Further, the third surface P3 of the polarized beam splitter 180 is an emission surface in the second direction 300b, and an angle θ3 between the normal vector N3 of the third surface P3 and the rotation axis R is approximately 90 degrees.

In addition, an angle θ2 between the normal vector N2 of the second surface (film formation surface) P2 of the polarized beam splitter 180 and the rotation axis R is, for example, 45 degrees.

In addition, as shown in FIG. 20, the normal vector N3 of the third surface P3 of the polarized beam splitter 180 and the normal vector N2 of the second surface P2 are not parallel to each other. An angle θ23 between the normal vector N2 and the normal vector N3 is, for example, 0.5 degrees.

In the second configuration example, measurement light moving in the first direction 300a is emitted in a state of being inclined with respect to the rotation axis R in accordance with an inclination θ5 of the fifth surface P5 and a relative refractive index of the optical path switching element 163 under the control of the linear polarization switching element 302.

In addition, measurement light that moves in the second direction 300b is emitted at an angle according to the relative refractive index of the optical path switching element 163 and the angle of incidence on the third surface P3 under the control of the linear polarization switching element 302. More specifically, in the case of the second configuration example, the angle of incidence on the third surface P3 of the measurement light reflected at the second surface (film formation surface) P2 and moving toward the third surface P3 is the angle θ23 (0.5 in this case).

In addition, assuming that a relative refractive index n of the optical path switching element 163 at an optical wavelength to be used is 1.5, the emission angle of the measurement light emitted from the third surface P3 is approximately 0.75 degrees according to Snell's law, and the light emitted from the third surface P3 is inclined by 0.25 degrees on the XY plane with respect to the light incident on the third surface P3, and thus surface coordinates are corrected and obtained in consideration of this inclination.

In the second configuration example, the same effects as in the first configuration example can be obtained. Furthermore, in the second configuration example, a normal vector between the normal N3 of the third surface P3 and the surface of the object T is inclined around the rotation axis R. Thereby, multiple reflection light generated between the third surface P3 and the surface of the object T is incident on the optical path switching element 163 again with an inclination with respect to the optical axis input from the lens unit 161, and thus the surface of the object T can be appropriately irradiated with the measurement light while reducing distance measurement noise caused by multiple reflection light.

### Third Configuration Example of Optical Path Switching Element 163

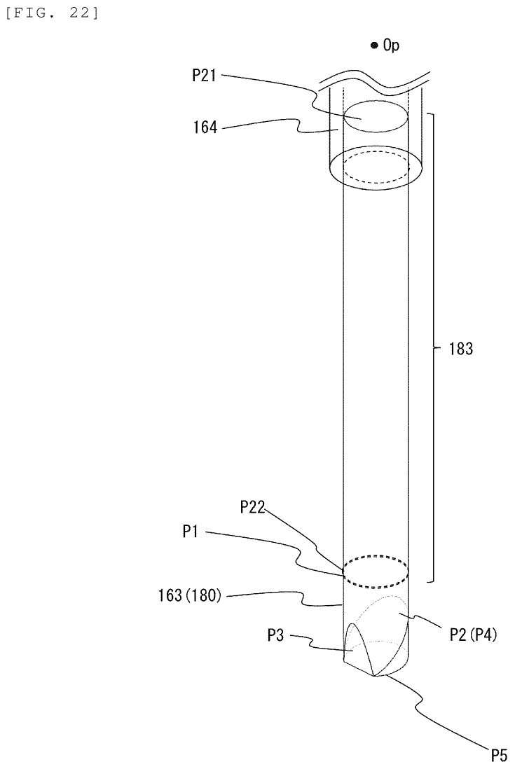

Next, FIG. 21 shows a third configuration example of the optical path switching element 163.

The third configuration example is obtained by adding a partial reflection surface P11 between the first surface P1 and the second surface P2 in the first configuration example (FIG. 13). The partial reflection surface P11 can be generated, for example, by irradiating the inside of the optical path switching element 163 with ultrashort pulsed laser light to change a refractive index.

In the third configuration example, a distance from a predetermined origin Op to the partial reflection surface P11 is measured by detecting reflected light of measurement light on the partial reflection surface P11 at the same time as measuring a distance to the surface of the object T. Thereby, it is possible to detect a change in the optical path length from the first surface P1 to the partial reflection surface P11 due to a change in the temperature of the optical path switching element 163, in addition to fluctuations in measured distances of the measurement head tip part 164 and the optical system in the front stage, and to correct results of the measurement of the distance to the surface of the object T.

In addition, a change in the optical path length of the entire optical path switching element 163 may be predicted by detecting a change in the distance between the first surface P1 and the partial reflection surface P11, and the optical path lengths from the partial reflection surface P11 to the third surface P3 and the fifth surface P5 may be corrected.

### Fourth Configuration Example of Optical Path Switching Element 163

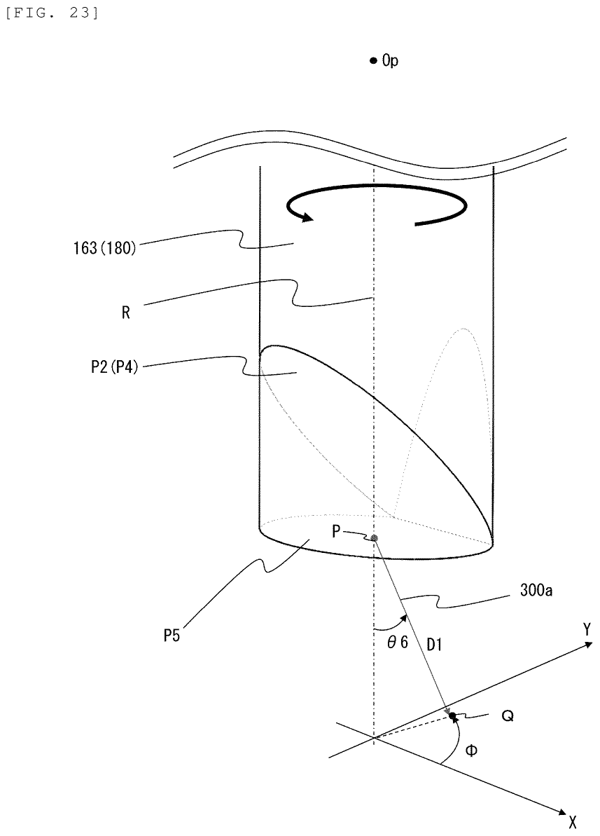

Next, FIG. 22 shows a fourth configuration example of the optical path switching element 163.

In the fourth configuration example, a glass rod 183 that transmits measurement light is added between the measurement head tip part 164 and the optical path switching element 163. The glass rod 183 has an upper end with a first surface P21 which is locked to the measurement head tip part 164. The glass rod 183 also has a lower end with a second surface P22 which is locked to the first surface P1 of the optical path switching element 163 by using an optical contact, an adhesive, or the like.

In the fourth configuration example, a distance from a predetermined origin Op to the first surface P21 is measured by detecting reflected light of measurement light on the first surface P21 of the glass rod 183 at the same time as measuring a distance to the surface of the object T. Further, at the same time, the reflected light of the measurement light which is reflected by the second surface P22 of the glass rod 183 is detected to measure a distance from the predetermined origin Op to the second surface P22. Then, it is possible to predict changes in the optical path lengths of the entire optical path switching element 163 and the glass rod 183 by grasping a fluctuation in a distance between the first surface P21 and the second surface P22 of the glass rod 183, and to correct the optical path length from the first surface P1 to the third surface P3 and the optical path length from the first surface P1 to the fifth surface P5.

In addition, the first surface P1 of the optical path switching element 163, the first surface P21 of the glass rod 183, and the like may be subjected to partial reflection coating in order to obtain a desired reflected light intensity, and the reflection at an interface between the first surface P1 of the optical path switching element 163 and the first surface P21 of the glass rod 183 may be controlled by providing a difference in the refractive index between the optical path switching element 163 and the glass rod 183.

<Method of Calculating Coordinates in First Direction 300a>

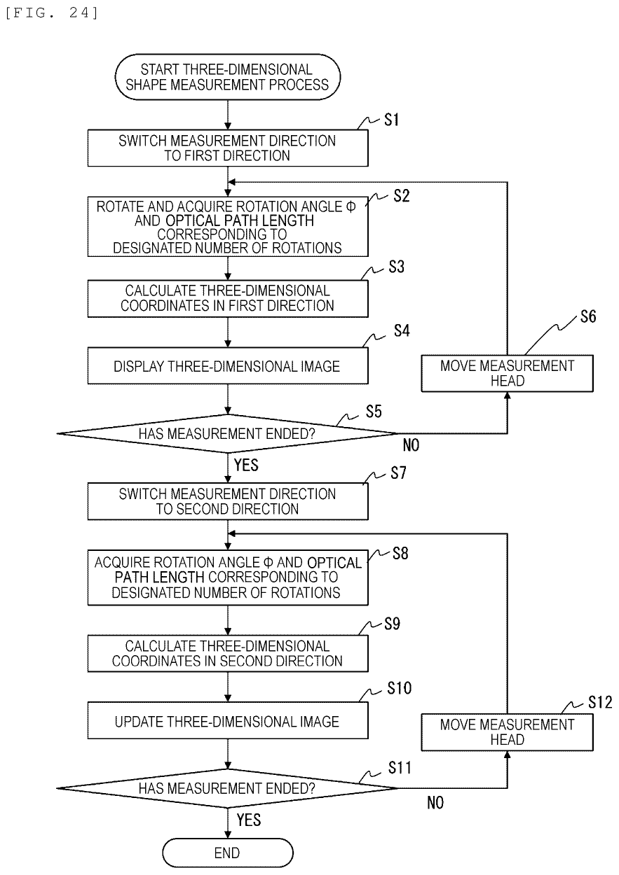

Next, FIG. 23 is a diagram showing a method of calculating surface coordinates of an object T using measurement light emitted from the optical path switching element 163 in the first direction 300a. Although FIG. 23 shows a case where the first configuration example of the optical path switching element 163 is used, a method of calculating coordinates in the first direction 300a is even in the second to fourth basically the same configuration examples, and thus the description thereof will be omitted.

As shown in the drawing, the measurement light moving in the first direction 300a is emitted onto the surface of the object T with an inclination of an angle θ6 with respect to the rotation axis R in accordance with the inclination of the fifth surface P5. The angle θ6 has a relationship of the following Formula (4) with an angle θ5 between the normal N5 of the fifth surface P5 and the rotation axis R in accordance with Snell's law.

$$n \cdot sin θ 5 = sin θ 6 \qquad ( 4 )$$

In addition, when the rotation angle in the first direction 300a by the rotation unit 162 is Φ, and a relative distance measurement value from coordinates P=(Xp, Yp, Zp) of an emission end surface of the fifth surface P5, which is obtained by design values and calibration, to a surface Q of the object T is D1, coordinates QP=(Qx, Qy, Qz) of the surface in the first direction 300a are obtained by the following Formula (5).

$$Qx = Xp + D 1 \cdot sin θ 6 \cdot cos Φ \qquad ( 5 )$$

$$Qy = Yp + D 1 \cdot sin θ 6 \cdot cos Φ$$

$$Qz = Zp - D 1 \cdot cos θ 6$$

Here, when scanning with measurement light is performed such that a conical trajectory with a point P as the apex is drawn by changing the rotation angle Φ by rotating the rotation unit 162, it is possible to measure a plurality of shapes in the first direction 300a without moving the measurement head 160 in the horizontal direction. Furthermore, it is possible to concentrically measure a plurality of shapes in the first direction by changing the Z coordinate of the measurement head 160 and performing rotational scanning at the rotation angle Φ.

Thus, for example, when the axial shape of a hole that is narrower than the outer diameter of the optical path switching element 163 is measured, the horizontal scanning amount of the measurement head 160 is limited, but in this embodiment, the shape of the object T in the first direction 300a can be measured without moving the measurement head 160 in the horizontal direction. This measurement method is not limited to a case where the internal shape of a hole is measured, and can be used for any shape measurement in the first direction 300a without being affected by a motion error of a horizontal movement axis.

### <Three-Dimensional Shape Measurement Process Performed by Shape Measurement Device 20>

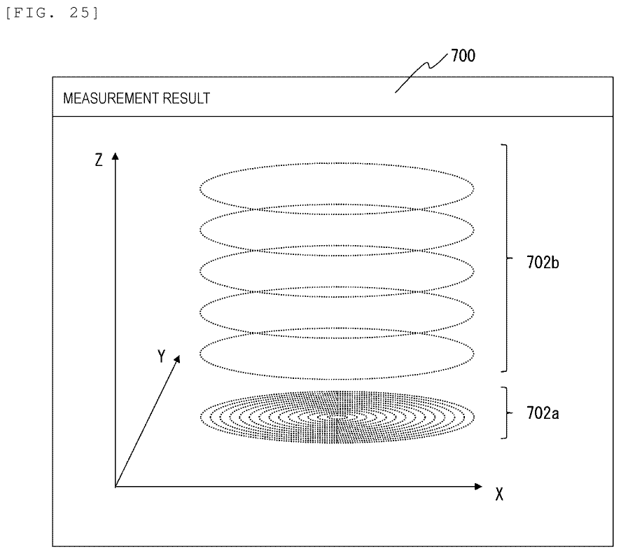

Next, FIG. 24 is a flowchart showing a three-dimensional shape measurement process performed by the shape measurement device 20 (FIG. 12).

The three-dimensional shape measurement process is started in response to, for example, a predetermined operation from a user on the calculation unit 260 of the shape measurement device 20.

First, the distance measurement control mechanism 110 switches the measurement direction to the first direction 300a under the control of the distance calculation unit 261 (step S1). When the measurement direction is already set to be the first direction 300a as the initial state, step S1 can be omitted.

Next, the measurement head 160 emits measurement light while rotating a designated number of times around the z-axis as the rotation axis R under the control of the distance calculation unit 261, and receives the reflected light. Then, the rotation angle Φ of the measurement head tip part 164 and the corresponding optical path length in the first direction 300a are acquired and output to the distance calculation unit 261 (step S2).

Next, the distance calculation unit 261 calculates the coordinates of the object T on the basis of the optical path length in the first direction 300a at each rotation angle Φ of the measurement head tip part 164 input from the measurement head 160, an effective length H1 of the measurement head tip part 164 in the first direction 300a, and the angle θ6 at which the measurement light is emitted in the first direction 300a, and outputs a calculation result to the shape calculation unit 262 (step S3).

Here, in the case of the measurement head tip part 164, the effective length H1 in the first direction 330a is a distance from a predetermined origin Op to a point P (FIG. 23) on the fifth surface P5 of the optical path switching element 163.

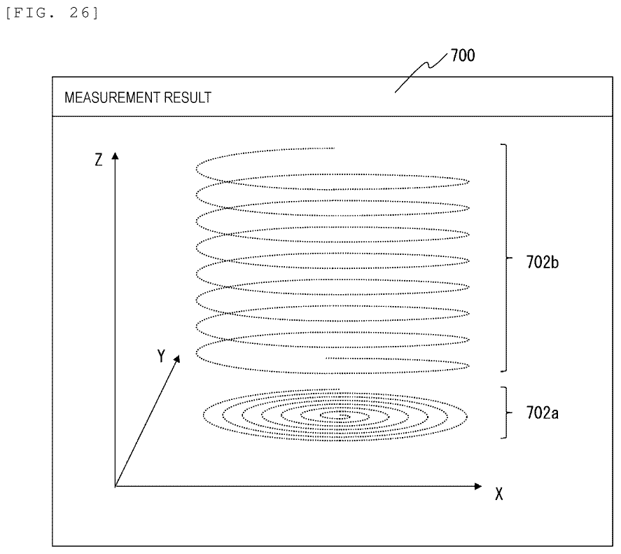

Next, the shape calculation unit 262 measures the shape of the object T using the calculation result input from the distance calculation unit 261, and displays an output screen 700 (FIG. 25) including a three-dimensional image of the object T on the display unit 250 (step S4).

FIG. 25 shows an example of display of the output screen 700 displayed on the display unit 250. As a result of the processing of steps S1 to S6, an image 702a of the bottom of the object T is displayed on the output screen 700. In addition, as a result of the processing of steps S7 to S12 to be described below, an image 702b of the side of the object T is displayed.

Returning back to FIG. 24, the calculation unit 260 then determines whether to end the three-dimensional shape measurement process (step S5). Specifically, the calculation unit 260 determines to end the three-dimensional shape measurement process, for example, when a predetermined operation is performed by a user, when it is detected that the measurement head 160 has come into contact with the object T, or when a previously designated number of repeated measurements has been reached.

Here, when the calculation unit 260 determines not to end the three-dimensional shape measurement process (NO in step S5), the movement mechanism 280 moves the measurement head 160 in the z direction by a predetermined distance ΔZ1 under the control of the movement mechanism control unit 263 (step S6).

Thereafter, the processing returns to step S2, and steps S2 to S6 are repeated. Thereby, the three-dimensional image of the object T in the first direction 300a displayed on the output screen 700 is accumulated concentrically when the surface of the object T that can be measured in the first direction 300a is substantially flat (image 702a in FIG. 25).

Thereafter, when the calculation unit 260 determines to end the three-dimensional shape measurement process (YES in step S5), the distance measurement control mechanism 110 then switches the measurement direction to the second direction 300b under the control of the distance calculation unit 261 (step S7).

Next, the measurement head 160 emits measurement light while rotating a designated number of times with the z-axis as the rotation axis R under the control of the distance calculation unit 261, and receives the reflected light. Then, the rotation angle Φ of the measurement head tip part 164 and the corresponding optical path length in the second direction 300b are acquired and output to the distance calculation unit 261 (step S8).

Next, the distance calculation unit 261 calculates the surface coordinates of the object T on the basis of the optical path length in the second direction at each rotation angle Φ input from the measurement head 160 and an effective length H2 of the measurement head tip part 164 in the second direction 300b, and outputs a calculation result to the shape calculation unit 262 (step S9).

Here, the effective length H2 in the second direction is a distance from a predetermined origin Op to a point where the direction of the measurement light changes on the second surface P2 of the optical path switching element 163 (hereinafter referred to as a direction change point). The reason why the direction of the measurement light changes may be reflection or refraction, but there may be other reasons.

Next, the shape calculation unit 262 measures the shape of the object T using the calculation result input from the distance calculation unit 261, and updates the three-dimensional image of the output screen 700 displayed on the display unit 250 (step S10).

Next, the calculation unit 260 determines whether to end the three-dimensional shape measurement process, as in step S5 (step S11). Here, when the calculation unit 260 determines not to end the three-dimensional shape measurement process (NO in step S11), the movement mechanism 280 moves the measurement head 160 in the z direction by a predetermined distance Δz2 under the control of the movement mechanism control unit 263 (step S12).

Regarding the movement of the measurement head 160, for example, when the internal shape of a hole of the object T is measured, the signs of the amounts of movement in the z direction (that is, a distance Δz1 and a distance Δz2) in steps S6 and S12 can be reversed to efficiently perform measurement in the first direction 300a on a going path and perform measurement in the second direction on a return path.

Thereafter, the processing returns to step S8, and steps S8 to S12 are repeated. Thereby, a three-dimensional image of the object T in the second direction 300b which is displayed on the output screen 700 is accumulated concentrically when the surface of the object T that can be measured in the second direction 300b is substantially cylindrical (image 702b in FIG. 25).

Thereafter, when the calculation unit 260 determines to end the three-dimensional shape measurement process (YES in step S11), the three-dimensional shape measurement process ends.

In the above-described three-dimensional shape measurement process, the coordinates of the object T are calculated in real time, and a three-dimensional image is displayed on the basis of the calculation results. However, after the measurement head 160 finishes moving in the z direction, the coordinates of the object T may be calculated and a three-dimensional image may be displayed on the basis of the calculation results.

In addition, the process of step S4 and the process of step S6 may be executed simultaneously. Similarly, the process of step S8 and the process of step S12 may be executed simultaneously.

FIG. 26 shows an example of display on the output screen 700 when the process of step S4 and the process of step S6 are executed simultaneously, and also when the process of step S8 and the process of step S12 are executed simultaneously. In this case, spiral images 700a and 700b are displayed on the output screen 700.

Furthermore, the order of the processes of steps S1 to S6 and the order of the processes of steps S7 to S12 may be reversed. Furthermore, only either the processes of steps S1 to S6 or the processes of steps S7 to S12 may be executed.

Although the moving direction of the measurement head 160 (including relative movement) is the z direction in the above-described three-dimensional shape measurement process, the moving direction is not limited to the z direction, and the measurement head 160 may be moved in a direction along the rotation axis R of the measurement head tip part 164.

However, in order to prevent elastic bending of the measurement head tip part 164, it is preferable that the rotation axis R of the measurement head tip part 164, which is substantially cylindrical, be aligned with the direction of gravity.

Alternatively, the measurement head 160 may be fixed without being moved, and a relative position between the measurement head 160 and the object T may be changed by moving the object T. In this case, the measurement head 160 is not moved, and thus it is possible to avoid the measurement head tip part 164 from bending due to acceleration and deceleration at the time of moving or stopping. Alternatively, even when the measurement head 160 is moved, it is preferable that the measurement head 160 be moved along the rotation axis R of the measurement head tip part 164. However, this is not necessary when the measurement head 160 is moved relative to the object T.

The invention is not limited to the above-described embodiment, and various modifications can be made. For example, the above-described embodiment has been described in detail to describe the invention in an easy-to-understand manner, and is not necessarily limited to having all of the configurations described. In addition, a part of the configuration of one embodiment can be replaced with or added to the configuration of another embodiment.

With regard to the above-described configurations, functions, processing units, and the like, some or all of these may be realized by hardware, for example, by being designed as an integrated circuit. Further, the above-described configurations, functions, and the like may be realized by software by a processor analyzing and executing a program for realizing each of the functions. Information such as programs, tables, and files for realizing the functions can be placed in a recording device such as a memory, a hard disk, or an SSD or a recording medium such as an IC card, an SD card, or a DVD. In addition, the control lines and information lines are those that are considered to be necessary for the description, and not all control lines and information lines in the product are necessarily shown. In reality, it may be considered that almost all components are connected to each other.

### REFERENCE SIGNS LIST

10: distance measurement device
20: shape measurement device
110: distance measurement control mechanism
111: distance measurement control mechanism control unit
150: connection cable
160: measurement head
161: lens unit
162: rotation unit
163: optical path switching element
164: measurement head tip part
165: first polarization state control unit
166: second polarization state control unit
168: opening
180: polarized beam splitter
183: glass rod
300a: first direction
300b: second direction

1. A shape measurement device comprising:
a measurement head, wherein
the measurement head includes
a probe that is locked to a tip of the measurement head,
a rotation unit that rotates the locked probe, and
an optical element that emits measurement light to the probe,
the probe includes an optical path switching element that switches an optical path of the measurement light incident from the optical element,
the optical path switching element has
a first surface on which the measurement light incident from the optical element is incident,
a second surface that reflects the measurement light incident from the first surface,
a third surface that emits the measurement light reflected by the second surface to an object,
a fourth surface that is in contact with the second surface, and
a fifth surface that emits the measurement light having passed through the second surface to the object,
the optical path switching element is capable of controlling a reflection ratio of the measurement light at the second surface and includes a first transmissive member having the first surface, the second surface, and the third surface, and a second transmissive member having the fourth surface and the fifth surface,
an angle between a normal of the second surface and a rotation axis of the probe is greater than 45 degrees,
an angle between a normal of the third surface and the rotation axis is less than 90 degrees, and
a normal of the fifth surface is not parallel to the rotation axis.

2. The shape measurement device according to claim 1, wherein, when the normal of the second surface and the normal of the third surface are viewed from the fifth surface side or the first surface side in a direction of the rotation axis, the normal of the second surface and the normal of the third surface are not parallel to each other.

3. The shape measurement device according to claim 1, wherein, when the optical path switching element is viewed from the fifth surface side or the first surface side in the direction of the rotation axis, the optical path switching element has a circular shape or a shape in which a part of a circle is missing.

4. The shape measurement device according to claim 1, wherein
the measurement head includes a measurement head tip part to which the optical path switching element is locked and inside of which has a space through which the measurement light from the optical element passes, and
at least a portion of the third surface of the optical path switching element is exposed in the direction of the rotation axis beyond the measurement head tip part.

5. The shape measurement device according to claim 1, wherein an angle θ2 between the normal of the second surface and the rotation axis, and an angle θ3 between the normal of the third surface and the rotation axis satisfy the following formula,
(90−θ3)=(2n/n−1)(θ2−45)
where n is a relative refractive index of the optical path switching element.

6. The shape measurement device according to claim 1, wherein the optical path switching element has, between the first surface and the second surface, a partial reflection surface that reflects a portion of the measurement light toward the first surface.

7. The shape measurement device according to claim 1, wherein
the probe includes, between the optical element and the optical path switching element, a glass rod that transmits the measurement light incident from the optical element, and
the glass rod has partial reflection surfaces that reflect a portion of the measurement light at both ends thereof.

8. A shape measurement method using a shape measurement device including a calculation unit and a measurement head, wherein
the measurement head includes
a probe that is locked to a tip of the measurement head,
a rotation unit that rotates the locked probe, and
an optical element that emits measurement light to the probe,
the probe includes an optical path switching element that switches an optical path of the measurement light incident from the optical element,
the optical path switching element has
a first surface on which the measurement light incident from the optical element is incident,
a second surface that reflects the measurement light incident from the first surface,
a third surface that emits the measurement light reflected by the second surface to an object,
a fourth surface that is in contact with the second surface, and
a fifth surface that emits the measurement light having passed through the second surface to the object,
the optical path switching element is capable of controlling a reflection ratio of the measurement light at the second surface and includes a first transmissive member having the first surface, the second surface, and the third surface, and a second transmissive member having the fourth surface and the fifth surface,
an angle between a normal of the second surface and a rotation axis of the probe is greater than 45 degrees,
an angle between a normal of the third surface and the rotation axis is less than 90 degrees, and
a normal of the fifth surface is not parallel to the rotation axis, and
the shape measurement method comprising:
switching the optical path of the measurement light incident from the optical element to a direction of the fifth surface by the optical path switching element;
performing scanning with the measurement light emitted from the fifth surface to the object at an angle not parallel to the rotation axis by the rotation unit while rotating the probe; and
measuring the shape of the object that is present in the direction of the rotation axis based on reflected light from the object by the calculation unit.
